(19) United States
(12) Patent Application Publication
(10) Pub. No.: US 2014/0141773 A1
(43) Pub. Date: May 22, 2014

(54) Method, system and device for implementing automatic dual-number roaming

(71) Applicants: Dawei Qi, Shenzhen (CN); Yihui Peng, Shenzhen (CN); Haichao Yang, Shenzhen (CN)

(72) Inventors: Dawei Qi, Shenzhen (CN); Yihui Peng, Shenzhen (CN); Haichao Yang, Shenzhen (CN)

(73) Assignee: ZTE CORPORATION, Shenzhen, Guangdong (CN)

(21) Appl. No.: 14/130,813

(22) PCT Filed: Apr. 16, 2012
(86) PCT No.: PCT/CN2012/074130

§ 371 Date: Jan. 3, 2014

(30) Foreign Application Priority Data
Jul. 5, 2011 (CN) 201110186845.0

(51) Int. Cl. H04W 8/06

(52) U.S. Cl. CPC H04W 8/06
USPC 455/433

(57) ABSTRACT

The disclosure discloses a method, system and device for implementing automatic dual-number roaming. An International Roaming (IR) platform is provided between a Mobile Switching Center (MSC) device in an area A and an intelligent network device. For a Mobile Virtual Network Operator (MVNO) subscriber having a number of the area A and a number of an area B, the number of the area A is subscribed to an intelligent network platform on a Home Location Register (HLR) in the area A, and the number of the area B is subscribed to the intelligent network platform on an HLR in the area B; the number of the area A is directed to the IR platform, and the number of the area B is directed to the HLR in the area B. A number of the area A is selected when the subscriber turns on a terminal in the area A, a turn-on registration message is transmitted to the IR platform, intelligent subscription information of the subscriber is shielded by the IR platform. The method, system and device of the disclosure can avoid the waste of resources and relay risk due to triggering the intelligent network platform when an intelligent subscriber makes and answers a call in the area A.

### TECHNICAL FIELD

The disclosure relates to the field of communications, and in particular to a method, system and device for implementing automatic dual-number roaming.

### BACKGROUND

In order to take account of both resources of existing networks and profit of subscribers, an one-card-with-multiple-numbers service exists currently. As long as a subscriber uses a terminal and a Subscriber Identity Module (SIM) card, the subscriber can enjoy corresponding communication service under a specific condition or position, such as a Mobile Virtual Network Operator (MVNO) service.

A main objective of the MVNO service is: a certain communication operator of an area A (such as a country A) solves the problem of automatic dual-number roaming between two areas in one-card-with-multiple-numbers way by adopting a cooperative mode with a certain communication operator of an area B (such as a country B). An specific application principle is as shown in FIG. 1.

FIG. 1 is a diagram of a networking structure of existing intelligent service systems for solving automatic dual-number roaming between two areas in one card with two numbers way. As shown in FIG. 1, a process of implementing dual-number roaming by intelligent service systems includes:

1. An MVNO subscriber makes a calling call in the area A by using a number of the communication operator of the area A, and a Mobile Switching Center (MSC) requests subscription information of the subscriber to a Home Location Register (HLR) in the area A. When finding that the subscriber subscribes an intelligent network service, the MSC transmits a message to a Service Control Point (SCP) of an intelligent network platform to trigger an MVNO service calling procedure.

2. An MVNO subscriber makes a call in the area A by using a number of the area B, and an MSC in a roaming area requests subscription information of the subscriber to an HLR in the area B. This call is processed according to a normal international roaming calling procedure, the MSC transmits no message to the intelligent network platform.

3. An MVNO subscriber makes a called call in the area A by using a number of the area A, and the MSC requests subscription information of the subscriber to the HLR in the area A. When finding that the subscriber subscribes the intelligent network service, the MSC transmits a message to the SCP of the intelligent network platform to trigger an MVNO service called procedure.

4. An MVNO subscriber makes a called call in the area A by using a number of the area B, and the MSC in a roaming area requests subscription information of the subscriber to the HLR in the area B. This call is processed according to a normal international roaming called procedure, and the MSC transmits no message to the intelligent network platform.

Generally, procedures that an MVNO subscriber makes a calling call and a called call in the area B by using a number of the area A or area B are the same as the aforementioned conditions in the area A.

For actual applications of the existing automatic dual-number roaming service, only a very few subscribers may stay in the area B for a long time or be frequently located at the area B among subscribers located at the area B and applied for opening the MVNO service in the area A, whereas most of the subscribers are generally located at the area A. The intelligent network platform will be triggered firstly each time the MVNO subscriber making or answering a call in the area A by using a number of the area A. After completing processing, the intelligent network platform notifies the MSC to relay the call, so that the burden of the SCP of the intelligent network platform is increased. Moreover, if a failure occurs on the SCP of the intelligent network platform, normal call making and answering of the subscriber will be affected, and subscriber experience will be seriously affected, thus bringing a great adverse impact to the operators and further going against development of the MVNO service and extension of operation scales of the operators.

### SUMMARY

In view of this, the disclosure is desired to provide a method, system and device for implementing automatic dual-number roaming, so as to avoid the waste of resources and relay risk when implementing automatic dual-number roaming.

To this end, the technical solutions of the disclosure are as follows.

A method for implementing automatic dual-number roaming, an International Roaming (IR) platform is provided between an MSC device in an area A and an intelligent network device, the method includes: when a subscriber turns on a terminal in the area A and selects a number of the area A, a turn-on registration message is transmitted to the IR platform, and the IR platform shields intelligent subscription information of the subscriber, wherein

for an MVNO subscriber having a number of the area A and a number of the area B, the number of the area A is subscribed to an intelligent network platform on an HLR in the area A, and the number of the area B is subscribed to the intelligent network platform on an HLR in the area B; the number of the area A is directed to the IR platform, and the number of the area B is directed to the HLR in the area B.

Wherein, the process that the IR platform shields intelligent subscription information of the subscriber when the subscriber turns on a terminal in the area A and selects a number of the area A may include:

the IR platform determines, according to an International Mobile Subscriber Identity IMSIa number of the area A, that the subscriber currently uses the number of the area A, modifies a response message acquired by the HLR in the area A, shields the intelligent subscription information, and returns a modified location update response to a Visitor Location Register (VLR) in the area A.

Wherein, the modified location update response may include a Mobile Directory Number MDNa of the area A and indicate that the MDNa of the subscriber is not subscribed to an intelligent network.

Wherein, when the subscriber turns on the terminal in the area B and selects the number of the area A, the method may further include:

the IR platform determines, according to the IMSIa number of the subscriber in the area A, that the subscriber currently uses the number of the area A, modifies the response message, shields the intelligent subscription information, and returns the modified location update response to a VLRb in the area B, wherein the modified location update response includes the MDNa and indicates that the MDNa of the subscriber is not subscribed to the intelligent network.

Wherein, when the subscriber turns off the terminal, the method may further include:

the IR platform forwards an turn-off MSINACTIVE message to an HLRa in the area A according to the IMSIa number of the subscriber in the area A; after the HLRa in the area A returns an turn-off msinactive response message, the IR platform returns the turn-off msinactive response message to a VLRa in the area A, and updates current location information of the subscriber in an SCP.

A system for implementing automatic dual-number roaming, which is applied to a network environment including a core network in an area A, a core network in an area B and an intelligent network platform, and the network environment further includes an IR platform; and the system includes a subscription management unit and a trigger shielding unit, wherein

the subscription management unit is configured to, for an MVNO subscriber having a number of the area A and a number of the area B, subscribe the number of the area A to the intelligent network platform on an HLR in the area A, and subscribe the number of the area B to the intelligent network platform on an HLR in the area B, wherein the number of the area A is directed to the IR platform, and the number of the area B is directed to the HLR in the area B; and

the trigger shielding unit is configured to, when the subscriber turns on a terminal in the area A, select the number of the area A, and transmit a turn-on registration message to the IR platform to trigger the IR platform to shield intelligent subscription information of the subscriber.

Wherein, the IR platform may be configured to, when the subscriber turns on the terminal in the area A and selects the number of the area A, and when the IR platform shields the intelligent subscription information of the subscriber, determine, according to an International Mobile Subscriber Identity IMSIa number of the subscriber in the area A, that the subscriber currently uses the number of the area A, modify a response message acquired by the HLR in the area A, shield intelligent subscription information, and return a modified location update response to a VLR in the area A.

Wherein, the modified location update response may include a Mobile Directory Number MDNa of the area A and indicate that the MDNa of the subscriber is not subscribed to an intelligent network.

Wherein, when the subscriber turns on the terminal in the area B and selects the number of the area A, the IR platform may be further configured to:

determine, according to the IMSIa number of the subscriber in the area A, that the subscriber currently uses the number of the area A, modify the response message, shield the intelligent subscription information, and return the modified location update response to a VLRb in the area B, wherein the modified location update response includes the MDNa and indicates that the MDNa of the subscriber is not subscribed to the intelligent network.

Wherein, when the subscriber turns off the terminal, the IR platform may be further configured to:

forward an turn-off MSINACTIVE message to an HLRa in the area A according to the IMSIa number of the subscriber in the area A; return the turn-off msinactive response message to a VLRa in the area A and update current location information of the subscriber in an SCP after the HLRa in the area A returns an turn-off msinactive response message.

A device for implementing automatic dual-number roaming, as an IR platform, which is applied to a network environment including a core network in an area A, a core network in an area B and an intelligent network platform; the IR platform is configured to receive a turn-on registration message from a subscriber to shield intelligent subscription information of the subscriber, wherein

the subscriber selects the number of the area A when turning on a terminal in the area A; and

for an MVNO subscriber having a number of the area A and a number of the area B, the number of the area A is subscribed to an intelligent network platform on an HLR in the area A, and the number of the area B is subscribed to the intelligent network platform on an HLR in the area B; the number of the area A is directed to the IR platform, and the number of the area B is directed to the HLR in the area B.

Wherein, when shielding the intelligent subscription information of the subscriber, the IR platform may be configured to:

determine, according to an International Mobile Subscriber Identity IMSIa number of the subscriber in the area A, that the subscriber currently uses the number of the area A, modify a response message acquired by the HLR in the area A, shield intelligent subscription information, and return a modified location update response to a VLR in the area A; and

the modified location update response includes a Mobile Directory Number MDNa of the area A and indicates that the MDNa of the subscriber is not subscribed to an intelligent network.

Wherein, when the subscriber turns on the terminal in the area B and selects the number of the area A, the IR platform may be further configured to:

determine, according to the IMSIa number of the subscriber in the area A, that the subscriber currently uses the number of the area A, modify the response message, shield the intelligent subscription information, and return the modified location update response to a VLRb in the area B, wherein the modified location update response includes the MDNa and indicates that the MDNa of the subscriber is not subscribed to the intelligent network.

Wherein, when the subscriber turns off the terminal, the IR platform may be further configured to:

forward an turn-off MSINACTIVE message to an HLRa in the area A according to the IMSIa number of the subscriber in the area A; return the turn-off msinactive response message to a VLRa in the area A and update current location information of the subscriber in an SCP after the HLRa in the area A returns an turn-off msinactive response message.

The technology of implementing automatic dual-number roaming according to the disclosure can avoid the waste of resources and relay risk due to triggering to the intelligent network platform when the intelligent subscriber makes and answers a call in the area A.

### BRIEF DESCRIPTION OF THE DRAWINGS

FIG. 1 is a diagram of a networking structure of an MVNO service;

FIG. 2 is a diagram of a networking structure of an MVNO service adding an IR platform according to an embodiment of the disclosure;

FIG. 3 is a flowchart of an operation of selecting a number of an area A when an MVNO subscriber turns on a terminal in the area A according to an embodiment of the disclosure;

FIG. 4 is a flowchart of an operation of selecting a number of an area A when an MVNO subscriber turns on a terminal in an area B according to an embodiment of the disclosure;

FIG. 5 is a flowchart of an operation that an MVNO subscriber turns off a terminal by using a number of an area A according to an embodiment of the disclosure;

FIG. 6 is a simple diagram of a flow of implementing automatic dual-number roaming according to an embodiment of the disclosure; and

FIG. 7 is a diagram of a system of implementing automatic dual-number roaming according to an embodiment of the disclosure.

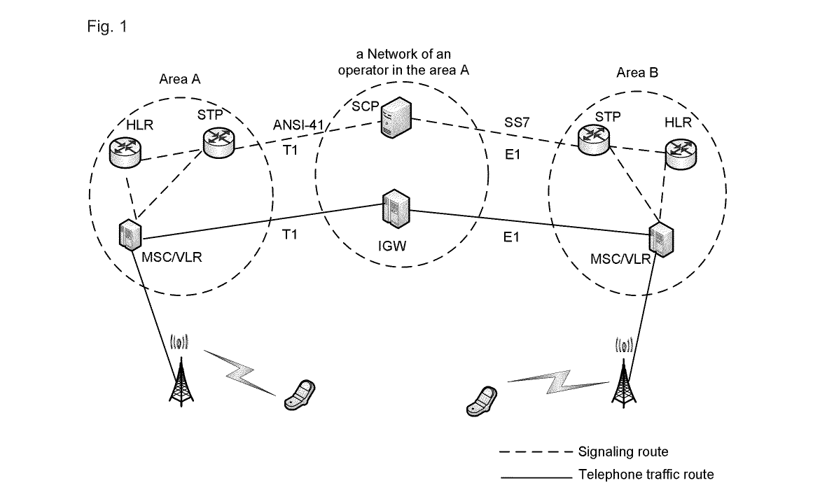

### DETAILED DESCRIPTION

In actual applications, a network device can be added between a core network device and an intelligent network device based on a combination application of core network and intelligent network services in a current network, for example, an IR platform is added between an MSC device in an area A and an intelligent network device.

an MVNO subscriber subscribes a number of the area A to an intelligent network platform on an HLR in the area A, and subscribes a number of an area B to the intelligent network platform on an HLR in the area B; the number of the area A is directed to the IR platform, and the number of the area B is directed to the HLR in the area B.

When a subscriber turns on a terminal in the area A and selects the number of the area A, a turn-on registration message is transmitted to the IR platform, and the IR platform shields intelligent subscription information of the subscriber.

Specifically, a subscriber in the area (such as a CDMA subscriber) A needs to apply an SIM card having an one-card-with-dual-numbers function and being capable of implementing the MVNO service, and the SIM card has two International Mobile Subscriber Identities (IMSIs). One of the two IMSIs is an number of the area A: IMSIa, which is provided by a communication operator in the area A, and is used for subscribing to an intelligent network on the HLR in the area A, and is directed to an SCP of the intelligent network platform; the other of the two IMSIs is an number of the area B: IMSIb, which is provided by a communication operator in the area B, and is used for subscribing to the intelligent network on the HLR in the area B, and is directed to the same SCP of the intelligent network platform with the IMSIa.

When an MVNO subscriber turns on a terminal in the area A and selects a number of the area A, the IR platform determines, according to the IMSI number of the subscriber in the area A, that the subscriber currently uses the number of the area A, then modifies a response message acquired by the HLR in the area A, shields the intelligent subscription information, and returns a modified location update response to a VLR in the area A.

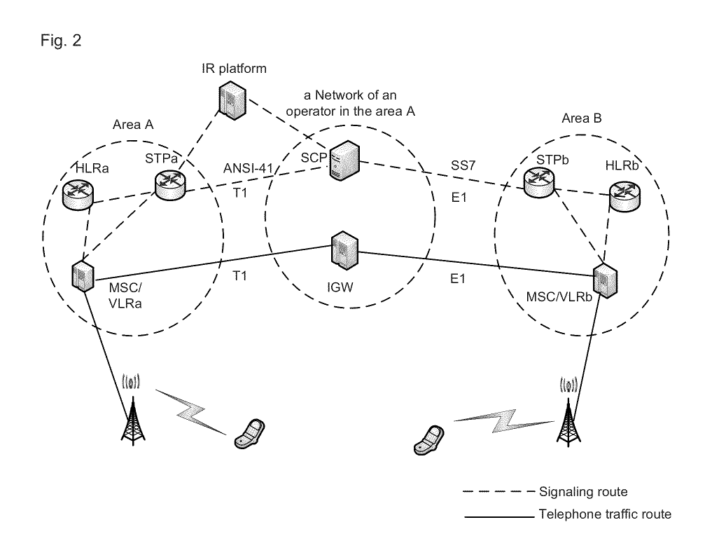

A schematic diagram of a networking structure on which an implementation scheme of the disclosure is based is as shown in FIG. 2, wherein, an MSC (an area A and an area B) processes all exchange and signalling functions of subscribers in the MSC area, and mainly processes functions like establishing (including authentication processing) of subscriber calls, call control and charging and the like.

A VLR (the area A and the area B) is in charge of storing and updating subscriber data of a mobile station roamed to the VLR area. The mobile station may register when entering a new location area, and the MSC receives registration information and transmits an identifier of the location area where the mobile station is located to the VLR. If the subscriber does not register yet, the VLR and the HLR exchange subscriber information. One VLR can be in charge of one or more MSC areas.

The HLR (the area A and the area B) is in charge of providing a function of managing subscriber information to a network. Basic service subscription information, supplementary service subscription information, some location information which make routing and charging of a call can be achieved and other information are included in the HLR.

An Inter-working Gateway (IGW) is in charge of connecting a telephone traffic route between a core network in the area A and a core network in the area B.

A Signalling Transfer Point (STP) is in charge of connecting a signalling route between a core network and the intelligent network platform.

An SCP provides a service logic processing program required for processing an intelligent service, and provides data required by the intelligent service.

An IP platform is configured to connect the core network in the area A and the intelligent network platform, and shield, when it is determined according to an IMSI number of an subscriber that the subscriber currently uses an number of the area A, intelligent subscription information of the subscriber on the HLR in the area A, so as to ensure that the intelligent network platform will not be triggered by a related call flow when the subscriber uses the number of the area A in the area A.

The aforementioned MSC/VLR, HLR, IR platform, and SCP are connected each other by an No. 7 signalling network. A Mobile Application Part (MAP) protocol is applied between the HLR and the MSC/VLR, IR platform, and SCP. A CAMEL Application Part (CAP) protocol is applied between the SCP and the MSC. An ISDN User Part (ISUP) signalling and Telephone User Part (TUP) signalling are applied between the MSC/VLR and IGW in the area A and the MSC/VLR in the area B.

The disclosure is specifically described with reference to the drawings and embodiments.

### Embodiment 1

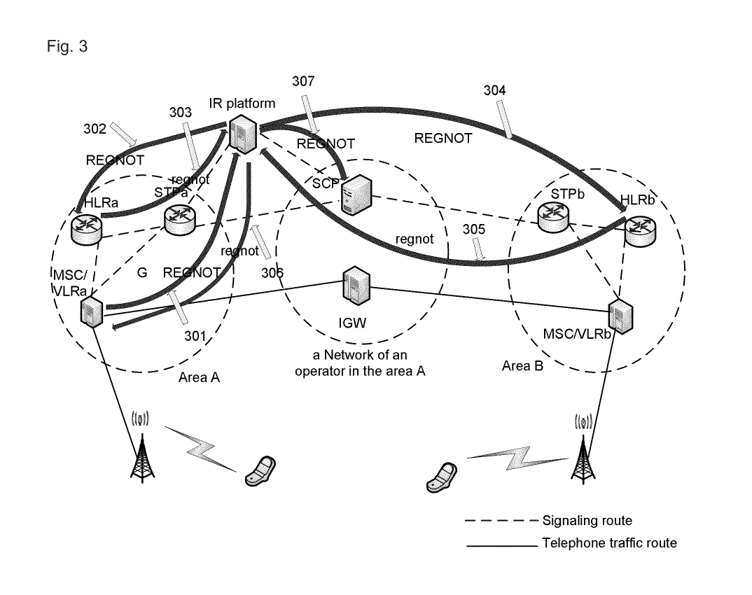

An MVNO subscriber selects a number of an area A when turning on a terminal in the area A, as shown in FIG. 3. The process includes the following steps:

Step 301: the MVNO subscriber selects the number of the area A when turning on the terminal in the area A, and an MSCa in the area A initiates a REGNOT (location update request) message to an IR platform (virtual HLR) according to an IMSIa number of the subscriber;

the REGNOT message includes a Mobile Directory Number (MDN) of the area A and indicates that the MDN in the area A of the subscriber is not subscribed to an intelligent network; therefore, a call flow can be completed independently by a core network, so as to ensure that the intelligent network platform will not be triggered when the MVNO subscriber makes a calling call and called call in the area A by using the number of the area A, and a load of an SCP of the intelligent network platform is reduced; moreover, normal call making and answering of the subscriber will not be affected if a failure occurs in the SCP of the intelligent network platform, thus avoiding bringing a adverse impact to the operators, and further facilitating development of the MVNO service and extension of operation scales of the operators;

Step 302: the IR platform, as a VMSC (virtual MSC), forwards the REGNOT message to an HLRa according to the IMSIa number of the subscriber;

Step 303: the HLRa in the area A returns the number of the area A MDNa and intelligent subscription information;

Step 304: if the IR platform is allowed to interact with an HLRb in the area B as a VMSC, then the IR platform forwards the REGNOT message to the HLRb according to an IMSIb number of the subscriber;

Step 305: the HLRb in the area B returns turn-off information of a number of the area B;

Step 306: the IR platform determines, according to the IMSIa number of the subscriber, that the subscriber currently uses the number of the area A, then modifies a response message, shields the intelligent subscription information, and returns a modified location update response to the VLRa, wherein the REGNOT message includes the MDNa and indicates that the MDNa of the subscriber is not subscribed to an intelligent network; and

Step 307: the IR platform notifies the SCP to update current location information of the subscriber (according to the ID of the MSC initiating a location update request), and the SCP notifies a short message gateway.

### Embodiment 2

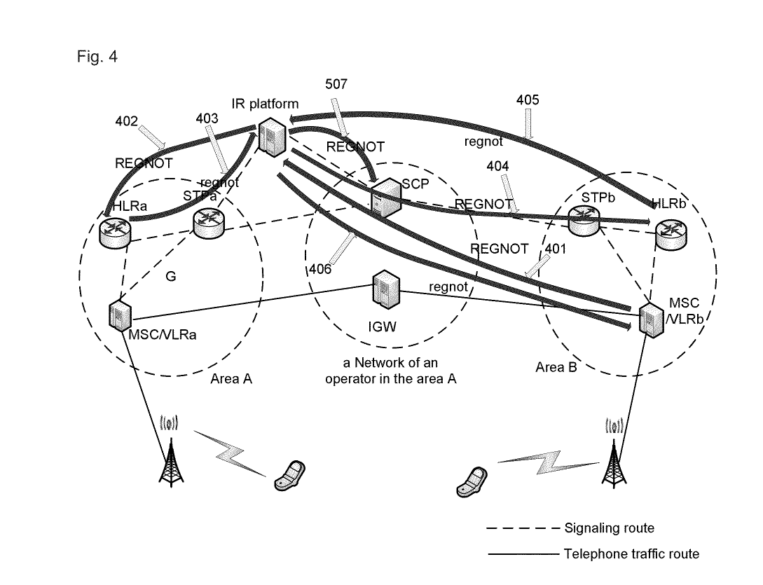

An MVNO subscriber selects a number of the area A when turning on a terminal in the area B, as shown in FIG. 4. The process includes the following steps:

Step 401: after the MVNO subscriber selects the number of the area A when turning on the terminal in the area B, an MSCb in the area B initiates a REGNOT message to an IR platform (virtual HLR) according to an IMSIa number of the subscriber;

Step 402: the IR platform, as a VMSC, forwards the REGNOT message to an HLRa in the area A according to the IMSIa number of the subscriber;

Step 403: the HLRa in the area A returns an MDNa and intelligent subscription information to the IR platform;

Step 404: if the IR platform is allowed to interact with an HLRb in the area B as a VMSC, then the IR platform forwards the REGNOT message to the HLRb in the area B according to an IMSIb number of the subscriber;

Step 405: the HLRb in the area B returns turn-off information of a number of the area B to the IR platform;

Step 406: the IR platform determines, according to the IMSIa number of the subscriber, that the subscriber currently uses the number of the area A, then modifies a response message, shields the intelligent subscription information, and returns a modified location update response to the VLRb in the area B, wherein the REGNOT message includes the MDNa and indicates that the MDNa of the subscriber is not subscribed to an intelligent network; and

Step 407: the IR platform notifies an SCP to update current location information of the subscriber (according to the ID of the MSC initiating a location update request), and the SCP notifies a short message gateway.

### Embodiment 3

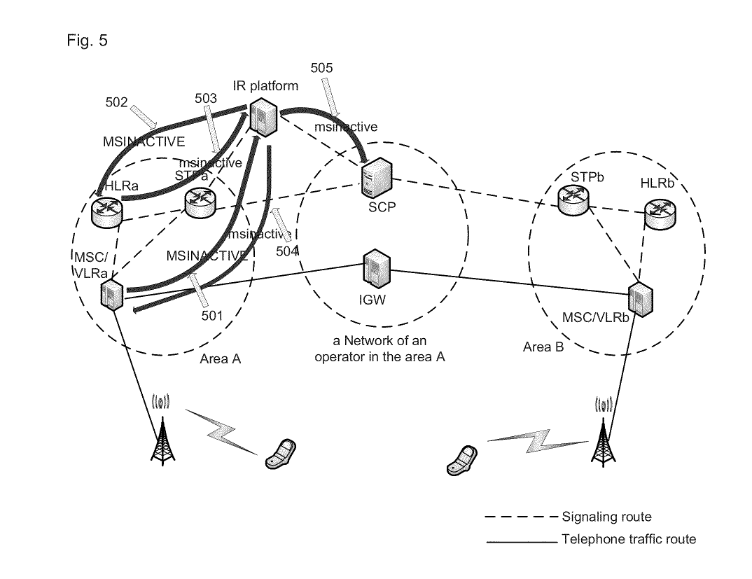

An MVNO subscriber turns off a terminal by using a number of the area A, as shown in FIG. 5. The process includes the following steps:

Step 501: the MVNO subscriber turns off the terminal, an MSCa in the area A transmits an turn-off MSINACTIVE (MS is inactive) message to an IR platform according to an IMSIa number of the subscriber;

Step 502: the IR platform, as a VMSC, forwards the turn-off MSINACTIVE message to an HLRa in the area A according to the IMSIa number of the subscriber;

Step 503: the HLRa in the area A returns a turn-off msinactive response message to the IR platform;

Step 504: the IR platform returns the turn-off msinactive response message to the VLRa in the area A; and

Step 505: the IR platform updates current location information of the subscriber of an SCP.

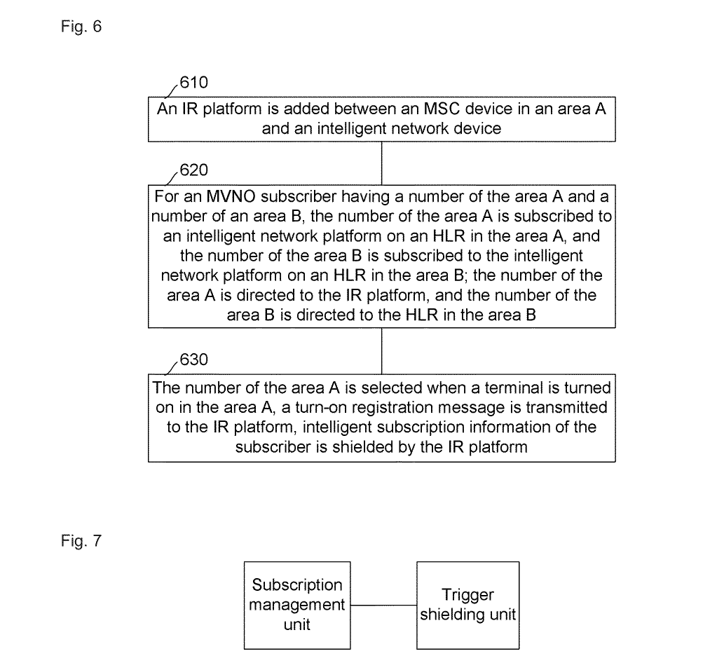

It can be seen from the aforementioned embodiments that an operation of implementing automatic dual-number roaming according to the disclosure can be represented as a flow shown in FIG. 6. The flow includes the following steps:

Step 601: an IR platform is added between an MSC device in an area A and an intelligent network device;

Step 602: for an MVNO subscriber having a number of the area A and a number of an area B, the number of the area A is subscribed to an intelligent network platform on an HLR in the area A, and the number of the area B is subscribed to the intelligent network platform on an HLR in the area B; and the number of the area A is directed to the IR platform, and the number of the area B is directed to the HLR in the area B; and

Step 603: the number of the area A is selected when a terminal is turned on in the area A, a turn-on registration message is transmitted to the IR platform, and intelligent subscription information of the subscriber is shielded by the IR platform.

In order to ensure smooth implementation of the aforementioned embodiments and operation ideas thereof, a setting shown in FIG. 7 can be performed. Referring to FIG. 7, FIG. 7 is a diagram of a system for implementing automatic dual-number roaming according to an embodiment of the disclosure. The system includes a connected subscription management unit and trigger shielding unit, and the system is applied to a network environment including a core network in an area A, a core network in an area B, an IR platform and an intelligent network platform.

In actual applications, for an MVNO subscriber having a number of the area A and a number of the area B, the subscription management unit can subscribe the number of the area A to the intelligent network platform on an HLR in the area A, and subscribe the number of the area B to the intelligent network platform on an HLR in the area B, wherein the number of the area A is directed to the IR platform, and the number of the area B is directed to the HLR in the area B.

When the subscriber turns on a terminal in the area A, the trigger shielding unit can select the number of the area A, and transmit a turn-on registration message to the IR platform to trigger the IR platform to shield intelligent subscription information of the subscriber.

It can be seen from the above description that, regardless of a method, a system or a device, the technology for implementing automatic dual-number roaming according to the disclosure can avoid the waste of resources and relay risk due to triggering the intelligent network platform when an intelligent subscriber makes and answers a call in the area A.

The above are only several embodiments of the disclosure in an MVNO service of a CDMA network, and are not intended to limit the disclosure. Any modifications, equivalent substitutions, improvements or the like made within the concept and principle of the disclosure shall fall within the scope of protection of the claims of the disclosure.

1. A method for implementing automatic dual-number roaming, an International Roaming (IR) platform is provided between a Mobile Switching Center (MSC) device in an area A and an intelligent network device, the method comprising: when a subscriber turns on a terminal in the area A and selects a number of the area A, transmitting a turn-on registration message to the IR platform, and shielding, by the IR platform, intelligent subscription information of the subscriber, wherein
for a Mobile Virtual Network Operator (MVNO) subscriber having a number of the area A and a number of an area B, the number of the area A is subscribed to an intelligent network platform on a Home Location Register (HLR) in the area A, and the number of the area B is subscribed to the intelligent network platform on an HLR in the area B; the number of the area A is directed to the IR platform, and the number of the area B is directed to the HLR in the area B.

2. The method according to claim 1, wherein the process that shielding, by the IR platform, intelligent subscription information of the subscriber when the subscriber turns on a terminal in the area A and selects a number of the area A, comprises:
determining, by the IR platform according to an International Mobile Subscriber Identity IMSIa number of the subscriber in the area A, that the subscriber currently uses the number of the area A, modifying a response message acquired by the HLR in the area A, shielding the intelligent subscription information, and returning a modified location update response to a Visitor Location Register (VLR) in the area A.

3. The method according to claim 2, wherein the modified location update response comprises a Mobile Directory Number MDNa of the area A and indicates that the MDNa of the subscriber is not subscribed to an intelligent network.

4. The method according to claim 1, wherein when the subscriber turns on the terminal in the area B and selects the number of the area A, the method further comprising:
determining, by the IR platform according to the IMSIa number of the subscriber in the area A, that the subscriber currently uses the number of the area A, modifying the response message, shielding the intelligent subscription information, and returning the modified location update response to a VLRb in the area B, wherein the modified location update response comprises the MDNa and indicates that the MDNa of the subscriber is not subscribed to the intelligent network.

5. The method according to claim 1, wherein when the subscriber turns off the terminal, the method further comprising:
forwarding, by the IR platform, an turn-off MSINACTIVE message to an HLRa in the area A according to the IMSIa number of the subscriber in the area A; after the HLRa in the area A returns an turn-off msinactive response message, returning, by the IR platform, the turn-off msinactive response message to a VLRa in the area A, and updating current location information of the subscriber in a Service Control Point (SCP).

6. A system for implementing automatic dual-number roaming, which is applied to a network environment comprising a core network in an area A, a core network in an area B and an intelligent network platform, and the network environment further comprises an International Roaming (IR) platform; and the system comprises a subscription management unit and a trigger shielding unit, wherein
the subscription management unit is configured to, for a Mobile Virtual Network Operator (MVNO) subscriber having a number of the area A and a number of the area B, subscribe the number of the area A to the intelligent network platform on a Home Location Register (HLR) in the area A, and subscribe the number of the area B to the intelligent network platform on an HLR in the area B, wherein the number of the area A is directed to the IR platform, and the number of the area B is directed to the HLR in the area B; and
the trigger shielding unit is configured to, when the subscriber turns on a terminal in the area A, select the number of the area A, and transmit a turn-on registration message to the IR platform to trigger the IR platform to shield intelligent subscription information of the subscriber.

7. The system according to claim 6, wherein the IR platform is configured to, when the subscriber turns on the terminal in the area A and selects the number of the area A, and when the IR platform shields the intelligent subscription information of the subscriber, determine, according to an International Mobile Subscriber Identity IMSIa number of the subscriber in the area A, that the subscriber currently uses the number of the area A, modify a response message acquired by the HLR in the area A, shield intelligent subscription information, and return a modified location update response to a Visitor Location Register (VLR) in the area A.

8. The system according to claim 7, wherein the modified location update response comprises a Mobile Directory Number MDNa of the area A and indicates that the MDNa of the subscriber is not subscribed to an intelligent network.

9. The system according to claim 6, wherein when the subscriber turns on the terminal in the area B and selects the number of the area A, the IR platform is further configured to:
determine, according to the IMSIa number of the subscriber in the area A, that the subscriber currently uses the number of the area A, modify the response message, shield the intelligent subscription information, and return the modified location update response to a VLRb in the area B, wherein the modified location update response comprises the MDNa and indicates that the MDNa of the subscriber is not subscribed to the intelligent network.

10. The system according to claim 6, wherein when the subscriber turns off the terminal, the IR platform is further configured to:
forward an turn-off MSINACTIVE message to an HLRa in the area A according to the IMSIa number of the subscriber in the area A; return the turn-off msinactive response message to a VLRa in the area A and update current location information of the subscriber in a Service Control Point (SCP) after the HLRa in the area A returns an turn-off msinactive response message.

11. A device for implementing automatic dual-number roaming, as an International Roaming (IR) platform, which is applied to a network environment comprising a core network in an area A, a core network in an area B and an intelligent network platform; the IR platform is configured to receive a turn-on registration message from a subscriber to shield intelligent subscription information of the subscriber, wherein
the subscriber selects the number of the area A when turning on a terminal in the area A; and
for a Mobile Virtual Network Operator (MVNO) subscriber having a number of the area A and a number of the area B, the number of the area A is subscribed to an intelligent network platform on a Home Location Register (HLR) in the area A, and the number of the area B is subscribed to the intelligent network platform on an HLR in the area B; the number of the area A is directed to the IR platform, and the number of the area B is directed to the HLR in the area B.

12. The device according to claim 11, wherein when shielding the intelligent subscription information of the subscriber, the IR platform is configured to:
determine, according to an International Mobile Subscriber Identity IMSIa number of the subscriber in the area A, that the subscriber currently uses the number of the area A, modify a response message acquired by the HLR in the area A, shield intelligent subscription information, and return a modified location update response to a Visitor Location Register (VLR) in the area A; and
the modified location update response comprises a Mobile Directory Number MDNa of the area A and indicates that the MDNa of the subscriber is not subscribed to an intelligent network.

13. The device according to claim 11, wherein when the subscriber turns on the terminal in the area B and selects the number of the area A, the IR platform is further configured to:
determine, according to the IMSIa number of the subscriber in the area A, that the subscriber currently uses the number of the area A, modify the response message, shield the intelligent subscription information, and return the modified location update response to a VLRb in the area B, wherein the modified location update response comprises the MDNa and indicates that the MDNa of the subscriber is not subscribed to the intelligent network.

14. The device according to claim 11, wherein when the subscriber turns off the terminal, the IR platform is further configured to:
forward an turn-off MSINACTIVE message to an HLRa in the area A according to the IMSIa number of the subscriber in the area A; return the turn-off msinactive response message to a VLRa in the area A and update current location information of the subscriber in a Service Control Point (SCP) after the HLRa in the area A returns an turn-off msinactive response message.

15. The method according to claim 2, wherein when the subscriber turns on the terminal in the area B and selects the number of the area A, the method further comprising:
determining, by the IR platform according to the IMSIa number of the subscriber in the area A, that the subscriber currently uses the number of the area A, modifying the response message, shielding the intelligent subscription information, and returning the modified location update response to a VLRb in the area B, wherein the modified location update response comprises the MDNa and indicates that the MDNa of the subscriber is not subscribed to the intelligent network.

16. The method according to claim 3 wherein when the subscriber turns on the terminal in the area B and selects the number of the area A, the method further comprising:
determining, by the IR platform according to the IMSIa number of the subscriber in the area A, that the subscriber currently uses the number of the area A, modifying the response message, shielding the intelligent subscription information, and returning the modified location update response to a VLRb in the area B, wherein the modified location update response comprises the MDNa and indicates that the MDNa of the subscriber is not subscribed to the intelligent network.

17. The method according to claim 2, wherein when the subscriber turns off the terminal, the method further comprising:
forwarding, by the IR platform, an turn-off MSINACTIVE message to an HLRa in the area A according to the IMSIa number of the subscriber in the area A; after the HLRa in the area A returns an turn-off msinactive response message, returning, by the IR platform, the turn-off msinactive response message to a VLRa in the area A, and updating current location information of the subscriber in a Service Control Point (SCP).

18. The method according to claim 3, wherein when the subscriber turns off the terminal, the method further comprising:
forwarding, by the IR platform, an turn-off MSINACTIVE message to an HLRa in the area A according to the IMSIa number of the subscriber in the area A; after the HLRa in the area A returns an turn-off msinactive response message, returning, by the IR platform, the turn-off msinactive response message to a VLRa in the area A, and updating current location information of the subscriber in a Service Control Point (SCP).

19. The system according to claim 7, wherein when the subscriber turns on the terminal in the area B and selects the number of the area A, the IR platform is further configured to:
determine, according to the IMSIa number of the subscriber in the area A, that the subscriber currently uses the number of the area A, modify the response message, shield the intelligent subscription information, and return the modified location update response to a VLRb in the area B, wherein the modified location update response comprises the MDNa and indicates that the MDNa of the subscriber is not subscribed to the intelligent network.

20. The system according to claim 8, wherein when the subscriber turns on the terminal in the area B and selects the number of the area A, the IR platform is further configured to:
determine, according to the IMSIa number of the subscriber in the area A, that the subscriber currently uses the number of the area A, modify the response message, shield the intelligent subscription information, and return the modified location update response to a VLRb in the area B, wherein the modified location update response comprises the MDNa and indicates that the MDNa of the subscriber is not subscribed to the intelligent network.
